(19) United States
(12) Patent Application Publication
(10) Pub. No.: US 2007/0274509 A1
(43) Pub. Date: Nov. 29, 2007

(54) Sound volume control apparatus

(76) Inventor: Chun-Ru Zhao, Chiayi City (TW)

Correspondence Address: BIRCH STEWART KOLASCH & BIRCH, PO BOX 747, FALLS CHURCH, VA, 22040-0747, US

(21) Appl. No.: 11/415,121

(22) Filed: May 2, 2006

(51) Int. Cl. H04M 3/00; H04M 1/00; H04M 7/00

(52) U.S. Cl. 379/347

(57) ABSTRACT

A sound volume control apparatus connecting to a telephone signal line and an external sound equipment to tune down the sound volume of the external sound equipment so that telephone users can do telephone conversation without being interfered by the original excessive sound volume of the external sound equipment. After the conversation is finished, the sound volume of the external sound equipment is automatically returned to the original level. The invention further includes a forced returning mechanism to return the sound volume of the external sound equipment to the original level.

### FIELD OF THE INVENTION

The present invention relates to a control apparatus for sound amplifiers and particularly to a sound volume control apparatus to control the sound volume of an external sound equipment to prevent interference of user conversation on line telephones.

### BACKGROUND OF THE INVENTION

These days people value greatly leisure activities. To relieve the high pressure and tension occurred in the work places they often rely on some sensual stimulations such as visual or audio entertainment activities. To meet those needs a prolific of video and audio output equipment (such as televisions, home theater sets) having been introduced. While people enjoy the audio and video effect provided by those audio/video output equipments, conversation on the line telephone in the house often is interfered by excessive sound volume coming from those audio/video output equipments. As the length of the line telephone is limited, users cannot go away to adjust the sound volume of the audio/video output equipment. As a result, users of line telephone in the house often are interfered by the strong sound volume of the background music while they do conversation on the phone.

Similar problem also occurs in vehicles. To improve driving safety, many drivers use handfree handsets to minimize distraction during receiving or calling. The present handfree handsets generally have two types: one type communicates the earphone and microphone with the handset through lines, another type communicates the earphone and microphone with the handset through Bluetooth wireless approach. However, the handfree handset and the vehicle audio system mostly are independent from each other. In the event that the driver makes or receives a call on the phone while the vehicle audio system is operating, the phone conversation often is interfered due to its sound volume is smaller than that of the vehicle audio system. Then the driver has to tune down the sound volume of the vehicle audio system to hear the call clearer. The action of tuning the sound volume of the vehicle audio system increases the driving risk.

### SUMMARY OF THE INVENTION

Therefore the object of the present invention is to provide a sound volume control apparatus that can tune down the sound volume of an external sound equipment while conversation is undergoing to avoid the conversation from being interfered by the excessive original sound volume of the external sound equipment.

To achieve the foregoing object, the sound volume control apparatus of the invention is connected to a telephone signal source and an external sound equipment. In an embodiment of the invention the sound volume control apparatus includes a telephone signal pickup unit, a central processing unit (CPU), a sound volume control unit, an infrared receiver and an infrared transmitter. The telephone signal pickup unit picks up telephone signals input through a phone transmission line. The CPU receives and processes the telephone signals. After the CPU has received the telephone signals, the sound volume control unit is controlled and activated by the CPU to tune down the sound volume output by the external sound equipment. After the conversation is finished, the sound volume output by the external sound equipment can be returned to the original volume through the sound volume control unit. The infrared receiver and infrared transmitter may communicate with each other in a wireless fashion to release the control of tuning down sound volume of the sound volume control unit over the external sound equipment.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the sound volume control apparatus of the invention.

FIG. 2 is a circuit diagram of an embodiment of the sound volume control apparatus of the invention.

FIG. 3 is a circuit diagram of another embodiment of the sound volume control apparatus of the invention.

FIG. 4 is a flow chart of the sound volume control apparatus of the invention.

### DETAILED DESCRIPTION OF THE PREFERRED EMBODIMENTS

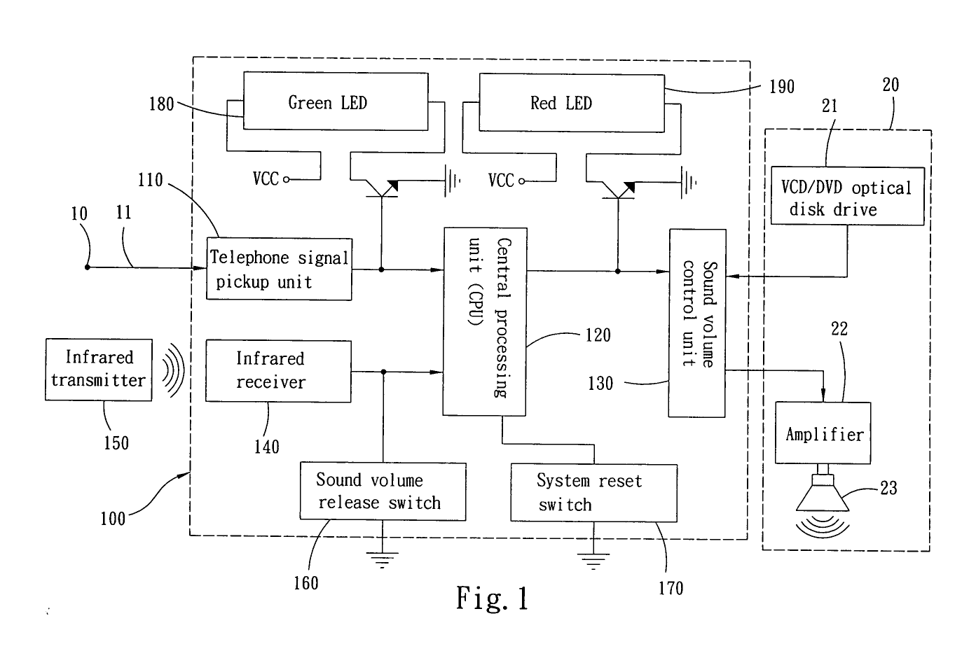

Please refer to FIG. 1, the sound volume control apparatus 100 of the invention is connected to a telephone signal source 10 and an external sound equipment 20. The telephone signal source 10 (such as an indoor telephone or a mobile phone) and the sound volume control apparatus 100 are connected through a land line 11 of a telecommunication institution or a mobile phone transmission line 11. The external sound equipment 20 may be a TV set, amplifier, home theater set or vehicle audio system or the like that can generate sound in any installed environment.

The sound volume control apparatus 100 in an embodiment of the invention includes a phone signal pickup unit 110, a CPU 120, a sound volume control unit 130, an infrared receiver 140 and an infrared transmitter 150.

The phone signal pickup unit 110 aims to pick up a telephone signal input from the telephone signal source 10. The telephone signal may be a calling signal or a sending signal. The CPU 120 is electrically connected to the phone signal pickup unit 110 to receive and process the telephone signal. The sound volume control unit 130 is electrically connected to the CPU 120 and the external sound equipment 20. After the CPU 120 has received and processed the telephone signal, it controls and activates the sound volume control unit 130 to tune down the sound volume output by the external sound equipment 20. After the conversation is finished, through the control of the sound volume control unit 130, the sound volume output by the external sound equipment 20 is returned to the original level through the sound volume control unit 130. More specifically, referring to FIG. 1, the external sound equipment 20 may include a VCD/DVD optical disk drive 21, an amplifier 22 and a speaker 23. The sound signal transmitted from the VCD/DVD optical disk drive 21 to the sound volume control unit 130 will be tuned sown. Then the amplifier 22 increases the intensity of the sound signal to drive the speaker 23. Finally the tuned down sound signal is transformed to sound wave audible to human ears.

By means of the construction set forth above, the sound volume control apparatus 100 can detect whether there is an input of the telephone signal. By tuning down the sound volume of the external sound equipment 20 telephone users can do conversation without being interfered by the excessive original sound volume of the external sound equipment 20.

Moreover, the infrared transmitter 150 (namely a remote controller) can emit a control signal. The infrared receiver 140 is electrically connected to the CPU 120 to receive the control signal and release the control of tuning down of sound volume from the sound volume control unit 130 over the external sound equipment 20. In addition, in another embodiment of the invention, the sound volume control apparatus 100 may be coupled with a sound volume release switch 160 which is electrically connected to the CPU 120. Such an approach can also release the control of tuning down of sound volume from the sound volume control unit 130 over the external sound equipment 20.

In short, after the conversation is finished the sound volume control apparatus 100 can automatically return the sound volume to the level prior to conversation. Through the infrared receiver 140 and infrared transmitter 150 or sound volume release switch 160, the setting of tuning down the sound volume can be released.

Furthermore, the sound volume control apparatus 100 may further include a system reset switch 170 which is electrically connected to the CPU 120 to return the sound volume control apparatus 100 to the initial setting condition.

The sound volume control apparatus 100 of the invention may also include a plurality of light emitting diodes (LEDs), such as a green LED 180 and a red LED 190 that are electrically connected to the CPU 120. These LEDs can emit or blink colored lights to indicate calling ringtone, pickup of the receiver or hanging up of the receiver.

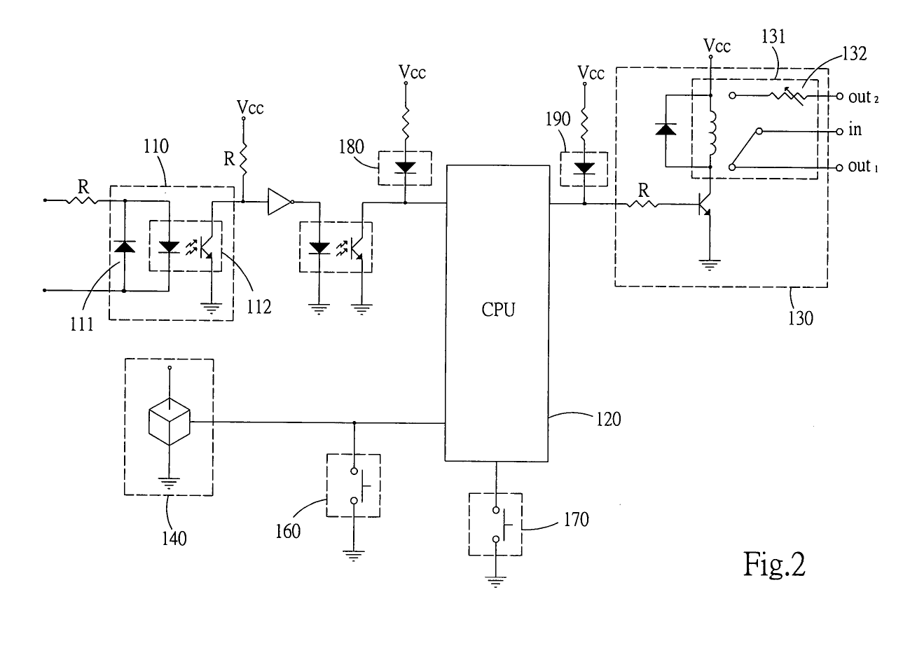

Refer to FIG. 2 for a circuit diagram of an embodiment of the invention. The phone signal pickup unit 110 includes a diode 111 and an optical coupling element 112. When the telephone signal is generated the diode 111 rectifies the current; the optical coupling element 112 picks up the pulse wave of the telephone signal. The phone signal pickup unit 110, aside from picking up the telephone signal, also can pick up the upper half cycle signal of the telephone signal (analog signal). Through an inverter, the signal is transformed to a driving voltage of a low potential to drive the green diode 180 to emit light. The CPU 120 receives the pulse wave of the telephone signal and activates the sound volume control unit 130. It is to be noted that in this embodiment the sound volume control unit 130 mainly includes a relay 131 and a resistor 132. Through the resistor 132 and the impedance of the external sound equipment 20 the sound volume of the external sound equipment 20 can be tuned down. The resistor 132 may be a variable resistor to be regulated mechanically to adjust the sound volume tuning down range of the external sound equipment 20. More specifically, in the embodiment set forth above, the tuned down sound volume may be set to ⅓ of the original sound volume. Of course, if the resistor 132 is a variable resistor to be regulated mechanically, users can manually set the sound volume tuning down range as desired.

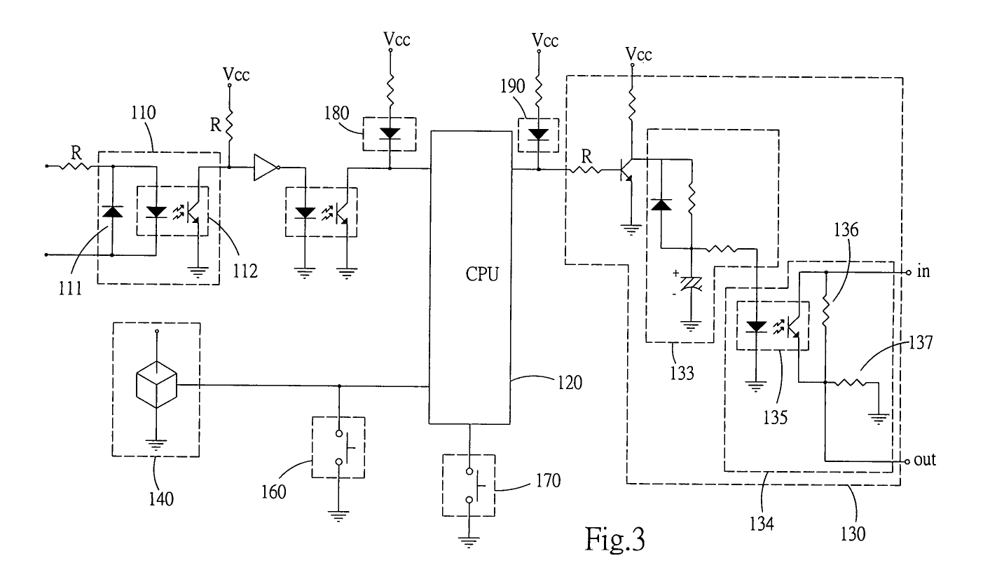

Refer to FIG. 3 for a circuit diagram of another embodiment of the invention. It differs from the previous embodiment in the sound volume control unit 130. This embodiment includes a delay circuit 133 and a sound volume regulation circuit 134. The sound volume regulation circuit 134 includes at least an optical coupler 135, a first resistor 136 and a second resistor 137. The optical coupler 135 includes a diode and a transistor. The first resistor 136 bridges the collector and emitter of the transistor. The second resistor 137 has one end connecting to the emitter of the transistor and another end grounding. The external sound equipment 20 (referring to FIG. 1) has a sound input end connecting to the collector of the transistor and a sound output end connecting to the emitter of the transistor. The design of such a delay circuit provides a buffer time to return the tuned down sound volume to the original sound volume so that users can accustom to the original sound volume more comfortably.

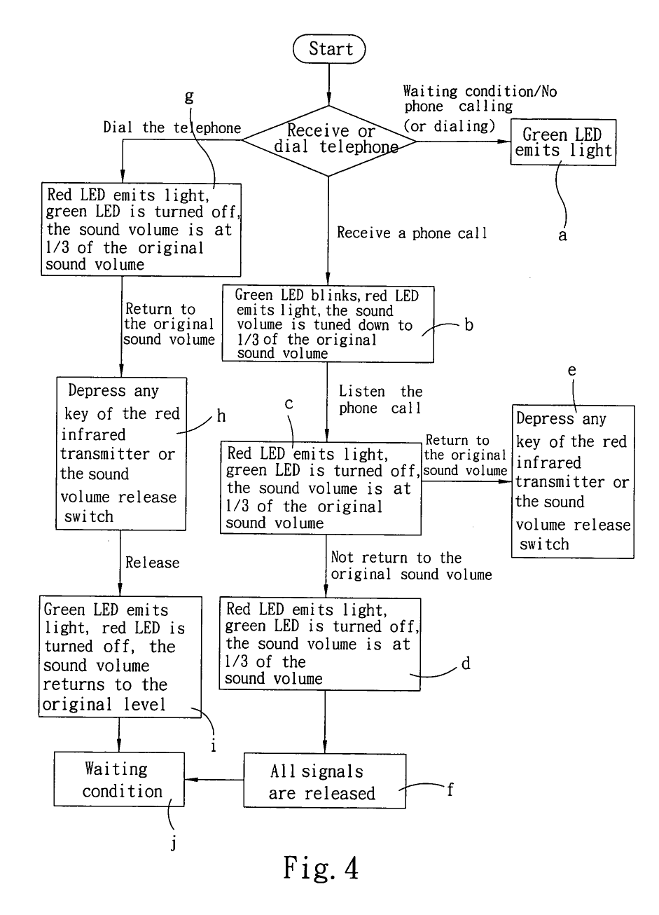

Referring to FIG. 4, when the sound volume control apparatus 100 is connected to a telephone transmission line, the green diode 180 emits light, and the external sound equipment 20 is at the normal sound volume (Procedure a). When a phone call is coming, the red diode 190 emits light and the green diode 180 blinks, and the sound volume is tuned down to ⅓ of the original sound volume (Procedure b). After the phone call is established, the green diode 180 is turned off and the red diode 190 emits light, and the sound volume is tuned to ⅓ of the original sound volume (Procedure c and d). Depress any key of the infrared transmitter 150 or the sound volume release switch 160 to make the turned down sound volume return to the original sound volume (Procedure e). Or after all the signals are released (Procedure f), the sound volume control apparatus 100 is back to the standby state (Procedure j). When a phone call is dialed, the red diode 190 emits light and the green diode 180 blinks once and is turned off, and the sound volume is tuned down to ⅓ of the original sound volume (Procedure g). After the phone call is finished, the red diode 190 and green diode 180 emit light at the same time. At that moment, depressing any key of the infrared transmitter 150 or the sound volume release switch 160 can return the tuned down sound volume to the original level (Procedure h). Then, the green diode 180 emits light and the red diode 190 is turned off, and the sound volume is back to original (Procedure i). In the end, the sound volume control apparatus 100 is back to the standby state (Procedure j).

In summary, the sound volume control apparatus of the invention provides at least the following benefits:

1. During a telephone call is made, the sound volume of the external sound equipment can be tuned down to a desired level to avoid interference of telephone conversation resulting from excessive original sound volume of the external sound equipment.

2. The sound volume control apparatus can be installed on a sound output equipment in any environment. It has a greater practicality and integrality. When adopted on an audio system in a vehicle, it can free users from the activities of adjusting the sound volume of the audio system. Hence driving safety can be enhanced.

What is claimed is:

1. A sound volume control apparatus connecting to a telephone signal source and an external sound equipment, comprising:
a telephone signal pickup unit to pick up a telephone signal input through a telephone transmission line;
a central processing unit (CPU) electrically connected to the telephone signal pickup unit to receive and process the telephone signal;
a sound volume control unit electrically connected to the CPU and the external sound equipment to be controlled and activated by the CPU after the CPU has received the telephone signal to tune down the sound volume output by the external sound equipment and return the sound volume output by the external sound equipment to an original level after telephone conversation is finished;
an infrared transmitter to emit a control signal; and
an infrared receiver electrically connected to the CPU to receive the control signal to release the control of sound volume tuning down of the sound volume control unit over the external sound equipment.

2. The sound volume control apparatus of claim 1 further including at least one light emitting diode (LED) which is electrically connected to the CPU to indicate calling ringtone, pickup of a telephone receiver and hanging of the telephone receiver.

3. The sound volume control apparatus of claim 1, wherein the telephone signal pickup unit includes at least one optical coupling element.

4. The sound volume control apparatus of claim 1 further including a sound volume release switch which is electrically connected to the CPU to release the control of sound volume tuning down of the sound volume control unit over the external sound equipment.

5. The sound volume control apparatus of claim 1 further including a system reset switch which is electrically connected to the CPU to return the sound volume control unit to an initial setting condition.

6. The sound volume control apparatus of claim 1, wherein the sound volume control unit includes at least a relay and a resistor, the relay including a first circuit and a second circuit, the resistor being coupled in series with the second circuit.

7. The sound volume control apparatus of claim 6, wherein the resistor is a variable resistor adjustable mechanically.

8. The sound volume control apparatus of claim 1, wherein the sound volume control unit includes at least a delay circuit and a sound volume regulation circuit.

9. The sound volume control apparatus of claim 8, wherein the sound volume regulation circuit includes at least an optical coupler, a first resistor and a second resistor, the optical coupler including a diode and a transistor, the first resistor bridging a collector and an emitter of the transistor, the second resistor having one end connecting to the emitter of the transistor and another end grounding, the external sound equipment having a sound input end connecting to the collector of the transistor and a sound output end connecting to the emitter of the transistor.
